(19) United States
(12) Patent Application Publication
(10) Pub. No.: US 2025/0178538 A1
(43) Pub. Date: Jun. 5, 2025

(54) VEHICLE ACCESSORY CARRIER SYSTEM

(71) Applicant: Partee Group LLC, Lake in the Hills, IL (US)

(72) Inventor: Jonathan Smith, Lake in the Hills, IL (US)

(21) Appl. No.: 19/049,627

(22) Filed: Feb. 10, 2025

Related U.S. Application Data
(63) Continuation-in-part of application No. 18/664,585, filed on May 15, 2024.
(60) Provisional application No. 63/467,946, filed on May 20, 2023.

(51) Int. Cl. B60R 7/06

(52) U.S. Cl. CPC B60R 7/06

(57) ABSTRACT

A vehicle accessory carrier system for mounting to opposing upright members of the vehicle, includes a mounting bar extending between the opposing upright members, The mounting bar has upper and lower surfaces having slots therein. An accessory carrier is removably mounted to the mounting bar and a system for removably mounting the accessory carrier to the mounting bar includes one or more clips. The clips have a rear wall, and upper and lower forwardly extending legs. The clip upper leg inserts into the mounting bar upper surface slot and the clip lower leg secures onto the mounting bar at the lower surface to secure the accessory carrier onto the mounting bar.

### CROSS-REFERENCE TO RELATED APPLICATION DATA

This application claims the benefit of and priority to Provisional U.S. Patent Application Ser. No. 63/467,946, filed May 20, 2023, titled Utility Basket for Golf Cart, and is a continuation-in-part of U.S. patent application Ser. No. 18/664,585, filed May 15, 2024, titled Vehicle Accessory Carrier System, the disclosures of which are incorporated herein in their entireties.

### BACKGROUND

The present disclosure is directed to a vehicle accessory carrier or caddy, and more particularly, to a carrier or caddy that mounts to a frame, such as a windshield frame of, for example, a golf cart.

Golfers and other golf cart users may carry beverages, such as water, wine, soda pop and the like when, for example, playing a round of golf, or driving around a golf cart community. It may, however, be difficult to store and maintain such beverages at a desired temperature, and within reach while operating the cart or waiting for play. Dashboard cup holders are known, however, known cup holders only hold cups, cans, bottles, and the like of a given size, and do not maintain the temperature of the stored drink.

Given the limited space in the passenger compartment of golf carts, often used hard-sided coolers must be secured to the back of such carts. This location is inconvenient in that it requires that an individual exit the cart, walk around to the rear of the cart and choose the desired drink.

Moreover, most hard sided coolers have open, unstructured interiors. While this may be advantageous in that more items can be stored in the cooler, it does not adequately secure what is stored therein. This can be particularly troublesome when the cooler is not full and the items in the cooler are unsecured and can tip or break.

Soft-sided coolers are also known, but they too are often located at the rear of the cart and it may be difficult to retrieve items form such coolers.

Accordingly, there is a need for an accessory carrier system that is readily reachable from the interior of the cart or other vehicle. Desirably, such a carrier system is readily mounted at an easily accessible location in the golf cart or vehicle. More desirably, such a carrier system can be configured as a storage caddy and can be used to store beverages such as water, wine, soda pop and the like and maintain the temperature of stored beverages. More desirably still, such a storage caddy system can securely store beverages in a manner that eliminates or reduces the opportunity for such beverages to tip and/or fall over when in use.

### BRIEF SUMMARY

In an aspect, a vehicle accessory carrier system is disclosed. The system mounts to opposing upright members of a windshield frame of the vehicle, such as a golf cart. The system includes a mounting bar extending between and operably connected to the opposing upright members and mounting clips for mounting the mounting bar to the opposing upright members. The mounting clips operably connect the mounting bar to the opposing upright members.

One or more storage containers are removably mounted to the mounting bar by a fastening system. In one aspect, the fastening system includes first and second mating engaging elements. The engaging elements removably attach the storage containers to the mounting bar. The first engaging element is affixed to the mounting bar and the second engaging element is mounted to the storage container. Other fastening systems include, for example, hook and loop fasteners such as VELCRO® fasteners, mechanical key/keyway fasteners and the like. Other fastening systems will be recognized by those skilled in the art.

In embodiments, the system further includes side rails mounted to the opposing upright members such that the mounting clips are mounted to side rails. The side rails are configured to vary a mounting height of the mounting bar.

The first and second engaging elements are interlocking elements. In an embodiment, the first engaging element can include a V-shaped receiving element and the second engaging element can include a V-shaped insert element. The insert element is configured for receipt in the receiving element. In embodiments, the receiving element has a base having upper and lower flanges to secure the receiving element to the mounting bar. The receiving element can have a pair of opposing V legs extending outwardly from the base, the V legs spaced from each other by a gap. The V legs have respective transverse portions extending from the base and inwardly extending portions at ends of the transverse portions. The inwardly extending portions define a receiving space between the inwardly extending portions and the base.

In an embodiment, the V legs define a reduced dimension in a downward direction of the legs. Gussets can be formed on outer surfaces of the V legs between the V legs and the base.

The insert element can include a front, a rear wall, and an interconnecting wall. In such an embodiment, slots are defined between the front wall, the rear wall, and the interconnecting wall.

The one or more storage containers each include contiguous upstanding front, rear and side walls, and a bottom wall to define an interior. The bottom wall is joined to the upstanding walls front, rear and side walls, and further includes a top wall releasably joined to the upstanding front and side walls.

The top wall is joined to the upstanding front and side walls by a closure, and is affixed to the rear wall such that the closure extends along the front and side walls. The closure can be, for example, a zipper. The one or more containers can further include a securing member, such as a strap to, for example, secure a cooling pack therein.

In an aspect, a vehicle accessory carrier system for mounting to opposing upright members of a windshield frame of the vehicle includes a mounting bar extending between and operably connected to the opposing upright members, mounting clips for mounting the mounting bar to the opposing upright members, the mounting clips operably connecting the mounting bar to the opposing upright members and one or more storage containers removably mounted to the mounting bar.

First and second mating engaging elements removably attach the storage containers to the mounting bar. The first engaging element is affixed to the mounting bar and the second engaging element is mounted to the storage container. Alternatively, a carrier, such as a wire basket can be mounted to the mounting bar to receive and hold/support a container or other items for storage.

In embodiments, the first engaging element includes a V-shaped receiving element and the second engaging element includes a V-shaped insert element The insert element is received in the receiving element. In embodiments, the receiving element has a pair of opposing legs extending outwardly from the base, which legs are spaced from each other by a gap. The legs have respective transverse portions extending from the base and inwardly extending portions at ends of the transverse portions. The inwardly extending portions defining a receiving space between the inwardly extending portions and the base. The legs define a reduced dimension in a downward direction of the legs.

The insert element has a front wall, a rear wall, and an interconnecting wall, and defines slots between the front wall, the rear wall, and the interconnecting wall. The insert element is positioned in the receiving element with the receiving element legs' inwardly extending portions positioned between the front walls and the rear walls of the insert portion and the interconnecting wall positioned in the receiving element gap.

In embodiments, the storage containers are coolers and each includes contiguous upstanding front, rear and side walls, and a bottom wall to define an interior. The bottom wall is joined to the upstanding walls front, rear and side walls, and the storage container further includes a top wall releasably joined to the upstanding front and side walls. The top wall is joined to the upstanding front and side walls by a zipper.

The coolers can further include a securing member on the interior. The securing member can be, for example, a strap for securing a cooling pack therein.

In another aspect, a vehicle accessory carrier system for mounting to opposing upright members of the vehicle includes a mounting bar extending between and operably connected to the opposing upright members, which mounting bar has upper and lower surfaces having slots therein, and one or more accessory carriers removably mounted to the mounting bar.

A mounting system for removably mounting one of the one or more accessory carriers to the mounting bar includes one or more clips. Each of the clips has a rear wall, an upper forwardly extending leg and a lower forwardly extending leg. The upper forwardly extending leg includes a forwardly extending hook. An end of the hook turns downward. The lower forwardly extending leg includes a forwardly extending foot having a securing member at or near an end of the lower leg foot.

In an embodiment, the clip upper forwardly extending leg hook inserts into the mounting bar upper surface slot and the clip lower forwardly extending leg securing member secures onto the mounting bar at about the lower surface slot to secure the accessory carrier onto the mounting bar. The clip can be formed from an elastically deformable material, such as a polymeric material.

In an embodiment, the securing member is an upwardly extending toe at or near an end of the foot. The upwardly extending toe inserts into the mounting bar lower surface slot. The securing member can be a lower leg bent toe at about the end of the lower leg foot, and the bent toe engages the mounting bar lower surface slot to secure the one of the one or more accessory carriers onto the mounting bar.

In embodiments the clip is formed integral with the accessory carrier. Alternatively, the clip is mounted to the accessory carrier.

In embodiments, the system further includes mounting rails and the mounting bar is mounted to the mounting rails. The mounting rails are adapted to mount to the opposing upright members of the vehicle.

In embodiments, the system includes mounting rails and angled mounting brackets. The angled mounting brackets are mounted to the mounting rails, and the mounting bar is mounted to the angled mounting brackets. The mounting rails are adapted to mount to the opposing upright members of the vehicle.

The angled mounting brackets can have a rail abutting leg, a bottom leg and upturned front lip at an end of the bottom leg. The mounting bar is positioned on the angled bracket with the upturned front lip inserted into the lower surface slot.

In embodiments, the rails have a bounded C-shaped cross-section. The system can include a lock for securing the mounting rail to the side rails. In embodiments, the lock is a sliding cam lock configured for sliding along the rail. The sliding cam lock has a finger extending therefrom for engagement with the mounting bar lower surface slot. The sliding cam lock includes a handle having a cam surface to engage the lock.

Accessory carriers include, for example, a cooler, a basket, a phone or tablet holder, and a cup holder.

In still another aspect, a vehicle accessory carrier system is configured for mounting to opposing upright members of the vehicle. The system includes a pair of side rails adapted to mount to the opposing upright members of the vehicle, and a mounting bar extending between and operably connected to the side rails. The mounting bar has upper and lower surfaces.

One or more accessory carriers are removably mounted to the mounting bar and a mounting system removably mounts one of the accessory carriers to the mounting bar. The mounting system includes one or more clips, each clip has a rear wall, an upper forwardly extending leg and a lower forwardly extending leg. The clip upper forwardly extending leg engages the mounting bar at about the upper surface and the clip lower forwardly extending leg engages the mounting bar at about the lower surface to secure the one of the accessory carriers onto the mounting bar.

In embodiments, the side rails have a bounded C-shaped cross-section. The mounting bar upper surface has a longitudinally extending slot, and the mounting bar lower surface has a longitudinally extending slot therein. In embodiments, the mounting system further includes angled mounting brackets mounted to the mounting rails. The mounting system can also include a sliding lock configured for sliding along the rail. In such an embodiment, the mounting bar is secured in place on and between angled mounting bracket and the sliding cam lock.

In embodiments, the clip upper forwardly extending leg includes a forwardly extending hook, an end of the hook turning downward, and the lower forwardly extending leg includes a forwardly extending foot having a securing member at or near an end of the lower leg foot. The clip upper forwardly extending leg hook inserts into the mounting bar upper surface slot and the clip lower forwardly extending leg securing member secures onto the mounting bar at about the lower surface slot to secure the one of the one or more accessory carriers onto the mounting bar.

The foregoing general description and the following detailed description are examples only and are not restrictive of the present disclosure.

### BRIEF DESCRIPTION OF THE DRAWINGS

The benefits and advantages of the present embodiments will become more readily apparent to those of ordinary skill in the relevant art after reviewing the following detailed description and accompanying drawings, wherein:

FIG. 1 illustrates an embodiment of a vehicle accessory carrier system or caddy system in accordance with the present disclosure;

FIG. 2 is a view of an embodiment of the caddy system showing a storage container removed from the mounting bar, and showing the engaging members in an exploded view;

FIG. 3 illustrates an embodiment of the caddy system with a bottle extending from one of the storage containers;

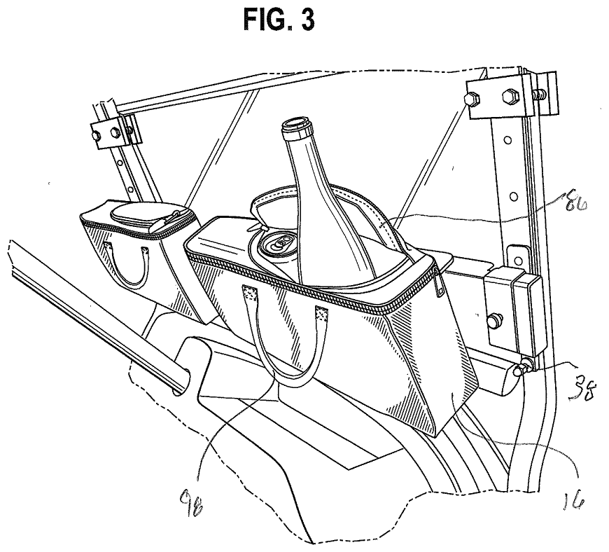

FIG. 4 is a top view of an embodiment of a storage container with a portion of the top open;

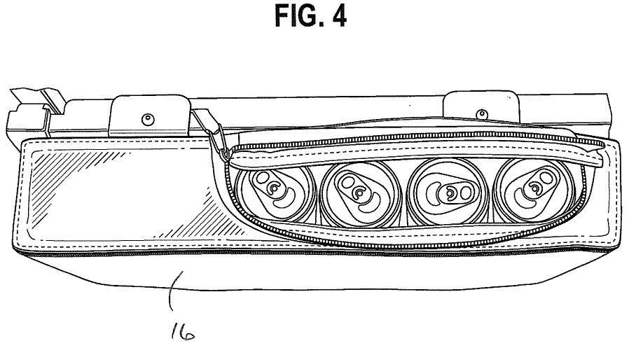

FIG. 5 is a view of an embodiment of a storage container partially broken away to illustrate one way in which a cooler pack is secured in the container;

FIG. 6 is a view of an embodiment of a storage container partially broken away to illustrate another way in which a cooler pack is secured in the container;

FIG. 7 is a rear view of an embodiment of the storage container;

FIG. 8 is a perspective view of an embodiment of the caddy system shown partially broken away to illustrate the engaging members securing the container to the mounting bar.

FIG. 9 illustrates another embodiment of a vehicle accessory carrier system mounting bar, the bar shown with a pair of mounting clips;

FIGS. 10 and 11 are side views of two mounting clips;

FIG. 12 illustrates the mounting bar in place on the vehicle side rails;

FIGS. 13 and 14 illustrate various accessories mounted to the mounting bar;

FIG. 15 shows the mounting bar mounted to the side rails and further illustrates the sliding clamp for securing the mounting bar to the side rails;

FIGS. 16 and 17 show an angle bracket as it is being installed on a side rail (FIG. 16) and as it is positioned on the side rail (FIG. 17);

FIGS. 18 and 19 show the sliding clamp on the side rail and as it is being positioned on the mounting bar (FIG. 18) and as it is installed on (clamped onto) the mounting bar; and

FIG. 20 illustrates an alternate clamp for securing the mounting bar to the side rails.

### DETAILED DESCRIPTION

While the present disclosure is susceptible of embodiment in various forms, there is shown in the drawings and will hereinafter be described presently preferred embodiments with the understanding that the present disclosure is to be considered an exemplification and is not intended to limit the disclosure to the specific embodiments illustrated.

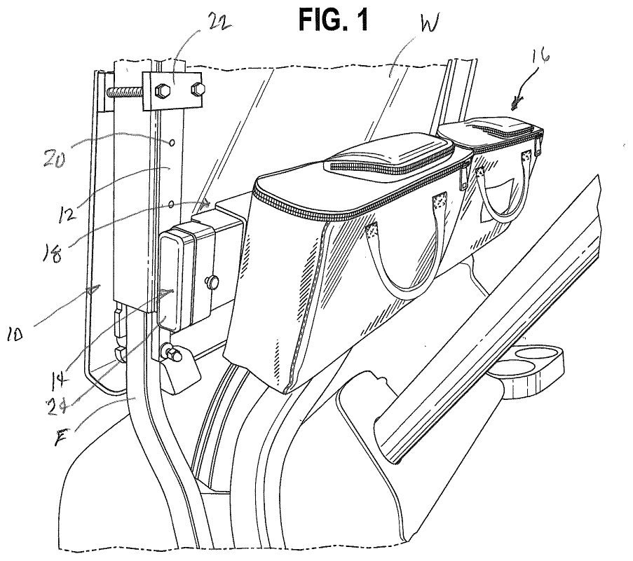

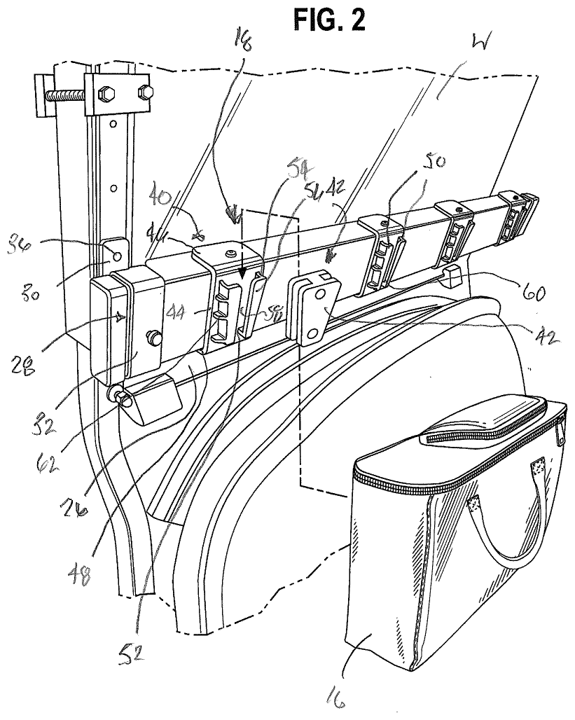

Referring now to the figures and in particular to FIGS. 1 and 2 there is shown an embodiment of a vehicle accessory carrier or caddy system 10. The illustrated caddy system 10 can be mounted to, for example, the frame F of a golf cart windshield or windscreen W. The system 10 includes generally a pair of side rails 12, a mounting bar 14, one or more storage containers 16, and a fastening system 18 to removably attach the storage members 16 to the mounting bar 14. In present system, the storage members 16 are coolers for storing, for example, cans, bottles, cups, and the like, but it will be appreciated that the containers 16 can be used to storage man different items.

The side rails 14 extend along the windshield frame F for mounting the caddy system 10 to the golf cart. The side rails extend 14 vertically along the windshield frame F and can include a series of holes or openings 20 as will be discussed in more detail below. In an embodiment, the side rails 12 are mounted to the windshield frame F by fasteners such as bolts, by clamps, as indicated at 22 or the like.

The mounting bar 14 extends laterally or horizontally between the windshield frame F uprights and the side rails 12. The mounting bar 14 can be, for example, an extrusion, such as an extruded aluminum bar. In one embodiment, the mounting bar can have a cross-sectional shape, such as a “C” shape or can have internal ribs or the like to impart strength and structural integrity to the mounting bar 14. The mounting bar 14 can include caps 24 at the respective ends of the bar 14 to close the ends of the bar 14 as needed.

In embodiments, the mounting bar 14 can have rearwardly extending lip or shelf 26 (rearwardly being toward the windshield W) to allow for storing additional items.

The mounting bar 14 is mounted to the side rails 12 and thus the windshield frame F of the vehicle. In an embodiment, mounting elements, such as clips 28 can be mounted to the side rails 12. In an embodiment, the clips 28 can have a flat mounting arm 30 to mount to the side rails 12. In embodiments, the clips 28 have a leg 32 that wraps around the mounting bar 14. The leg 32 can be an upturned leg or a side-turned leg such that the mounting bar 14 sits between the turned portion of the leg 32 and the flat mounting arm 30 of the clips 28. Alternatively, the clips 28 can be configured having an opening in the top of the clip such that the mounting bar 14 fits (e.g., slides) into the opening and is secured therein. The clips 28 can include an opening 36 that is aligned with one of the openings 20 in the side rails 12 to position the mounting bar 14 at selected height (i.e., at any of the openings 20 in the side rail 12) to adjust the height at which the mounting bar 14 and thus the containers 16 are mounted relative to the windshield W. In addition, the clips 28 can be configured to accommodate mounting bars 14 fitted to different widths of windshield frames F.

The clips 28 can be mounted to the side rails 12 and the mounting bar 14 to the clips 28 by fasteners 38 such as screws, knurled-head screws/bolts, and the like. It is envisioned that the mounting bar 14 is secured to the inside of the windshield frame F to provide easy access to the containers 16 for those inside of the cart. The lip or shelf 26 can extend to the windshield W for storage of other items.

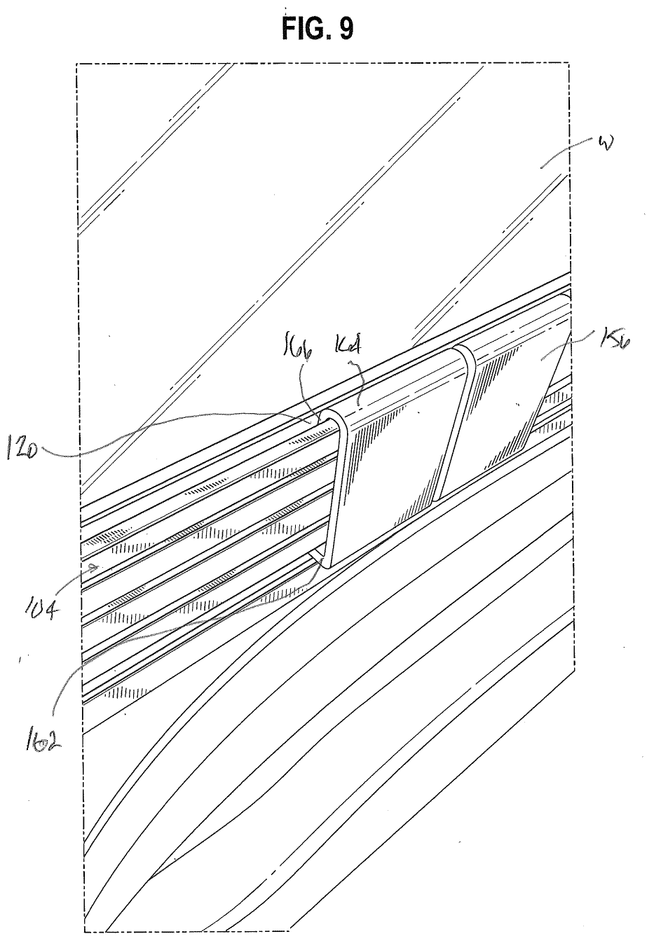

Referring now to FIGS. 2, 7 and 8, the one or more coolers 16 are secured to the mounting bar 14 by a fastening system 18. In embodiments, the fastening system 18 includes interlocking elements, such as mating engaging members 18. In embodiments, the engaging members 18 include mating V-shaped elements 40, 42, one portion 40 of which is secured to the mounting bar 14 and another portion 42 of which is secured to the cooler 16. In a present embodiment, a V-shaped receiving element 40 is mounted to the mounting bar 14 and a mating V-shaped insert element 42 is mounted to the cooler 16. It will be appreciated that the elements 40, 42 can be reversed such that the V-shaped receiving element 40 is mounted to the cooler 16 and a mating V-shaped insert element 42 is mounted to the mounting bar 14. In such a reversed configuration, the receiving and insert elements 40, 42 would be inverted, that is, upside down, with the larger, open end of the receiving element 40 V oriented downwardly.

The receiving element 40 has a base 44 having upper and lower flanges 46, 48 to secure the element 40 to the mounting bar 14 and a pair of opposing V legs 50 extending outwardly from the base 44. The legs 50 are spaced from each other by a gap 52. The legs 50 have respective transverse portions 54 extending from the base 44 and inwardly extending portions 56 at ends of the transverse portions 54. The inwardly extending portions 56 define a receiving space 58 between the inwardly extending portions 56 and the base 44. The V shape of the legs 50 defines an inward taper, as indicated at 60, in a downward direction of the legs 50. Gussets 62 can be formed on outer surfaces of the legs 50 between the legs 50 and the base 44 to provide additional strength, reinforcement, and structural integrity to the legs 50.

The receiving elements 40 can be mounted to the mounting bar 14 using fasteners such as screws, knurled-head screws/bolts, and the like. The receiving elements 40 can be mounted to the mounting bar 14 anywhere along the length of the mounting bar 14 to accommodate coolers 16 of different lengths or coolers having different insert element 42 locations.

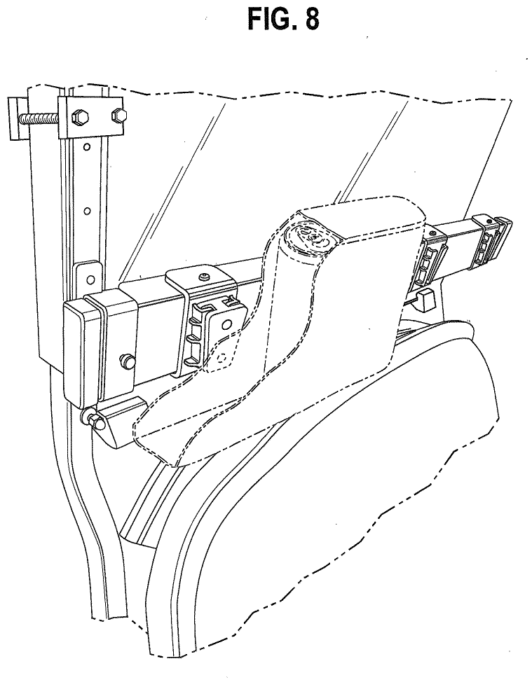

Referring to FIG. 7, the V shaped insert element 42 slides into and secures in the receiving element 40. The insert portion 42 includes front and rear walls 64, 66 and an interconnecting or bridge wall 68. Slots 70 are defined between the front and rear walls 64, 66 and the bridge wall 68. The rear wall 66 is positioned on and secured to a rear wall of the cooler 16. The insert element 42 is positioned in the receiving element 40 such that the receiving element legs' inwardly extending portions 56 fit between the front and rear walls 64, 66 of the insert portion 42, and the bridge or interconnecting wall 68 fits into the gap 52 between the legs 50 of the receiving element 40.

Other fastening systems include, for example, a hook and loop fastening system such as a VELCRO® fastening system, magnetic fasteners, a mechanical key/keyway fastening system and the like. Such other fastening systems will be recognized by those skilled in the art and are within the scope and spirit of the present disclosure.

Referring now to the various figures, as illustrated, the storage containers 16 are coolers. The coolers 16 each include contiguous upstanding front, rear and side walls 72, 74, 76, respectively. A bottom wall 78 is joined to the upstanding walls 72-76 and a top 80 is releasably joined to the upstanding walls 72-76. The top 80 can be joined to the upstanding front and side walls 72, 76 by a closure 82 such as a zipper and affixed to the rear wall 74 such that zipper 82 extends along three sides (the front 72 and two adjacent sides 76) of the cooler 16, and is used to open and close the cooler 16. A portion of the top 80 can include a closable portion or window 86 that can be opened to accommodate containers larger (taller) than the height of the upstanding walls 72-76, such as wine bottles. The window 86 can likewise include a closure 88 such as a zipper, a hook and loop fastener system, a snap closure, or the like. Alternatively, a carrier, such as a wire basket or the like can be mounted to the mounting bar 14 to receive the containers (such as the cooler or coolers 16) or other items for storage.

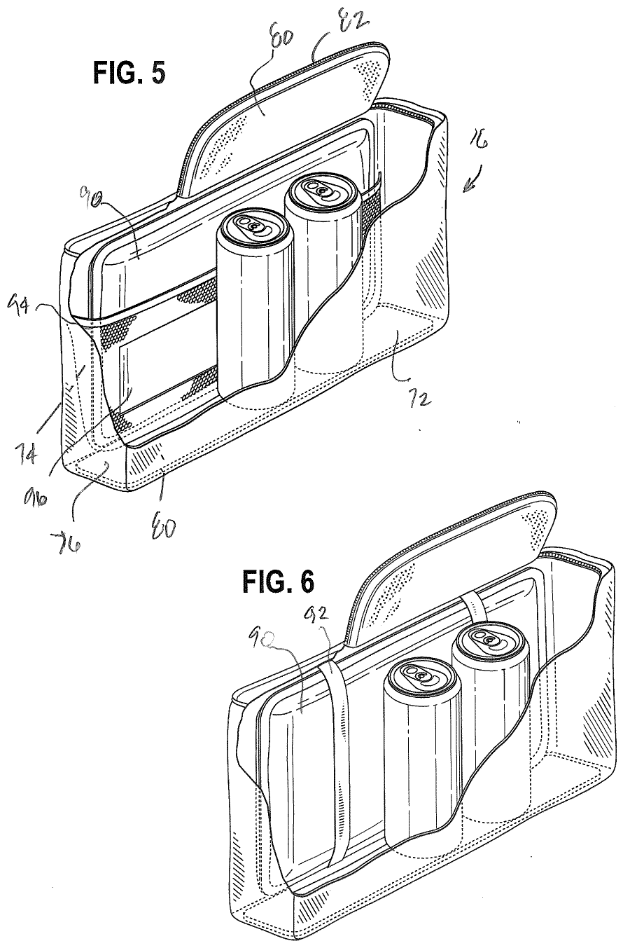

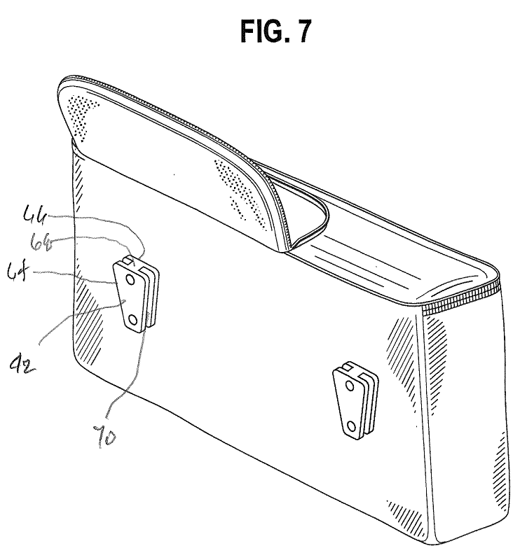

To maintain the cooler 16 contents at a desired temperature, the cooler 16 can include one or more cooling packs 90, such as those illustrated in FIGS. 5 and 6. It is envisioned that the cooling packs 90 will be relatively thin components and are fit into and secured in the cooler 16. In embodiments, the cooling packs 90 are mounted in the coolers 16 so that a surface of a cooling pack 90 is in contact with the beverages stored in the cooler 16. In an embodiment as seen in FIG. 6, the cooling packs 90 are maintained in place by straps 92, such as elastic straps to secure the cooling packs 90 in place. Alternatively, as seen in FIG. 5, the cooler 16 can include an envelope 94 into which the cooling packs are slipped, and the envelope 94 can have an open central window 96. In such arrangements, as noted above, the cooling pack 90 is in contact with the beverages in the cooler 16. The coolers 16 can include carry handles 98, for example, similar to a brief case, for ease of carrying the cooler 16 separate from the mounting system. Other handles, shoulder straps and the like will be recognized by those skilled in the art. The coolers 16 can also include an outside pocket (not shown) to, for example, hold a cell phone, keys, and the like.

It will be appreciated that the present vehicle accessory carrier system or caddy system 10, provides a secure and efficient way in which to store and carry items when in a golf cart or other similar vehicle. The present caddy system 10 allows the user to keep items, such as drinks cool and securely held while the vehicle is operated. Further, the present caddy system 10 can be used or mounted to most any golf cart or vehicle having an accessible windshield frame F to which the system 10 can be mounted.

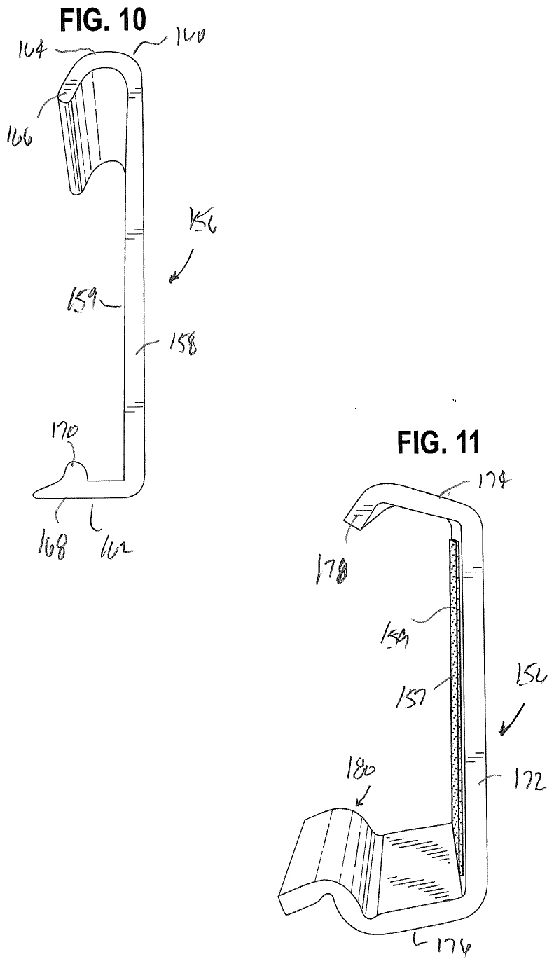

Another embodiment of the vehicle accessory carrier system or caddy system 100 is shown in FIGS. 9-19. As best seen in FIGS. 9, 12, 15 and 18-19, the system 100 can be mounted to, for example, the frame F of a golf cart windshield or windscreen W, or any vertical or substantially vertical rails R of a vehicle, and in some embodiments, mounted to angled rails of a vehicle. For example, some golf carts include front and rear seats and can include a pair of vertical or substantially vertical rails between the front and rear seats. Other golf carts may include a pair of rails behind the front seats of the cart. For purposes of the present disclosure, the vehicle vertical or substantially vertical rails will be referred to collectively as the “vehicle rails” or “vehicle vertical rails.”

The system 100 includes generally a pair of side rails 102, a mounting bar 104, one or more accessories 106 such as storage members, and a fastening system 108 to removably attach the accessories 106 to the mounting bar 104. The system 100 can also include a fastening system 110 to fasten the mounting bar 104 to the side rails 102.

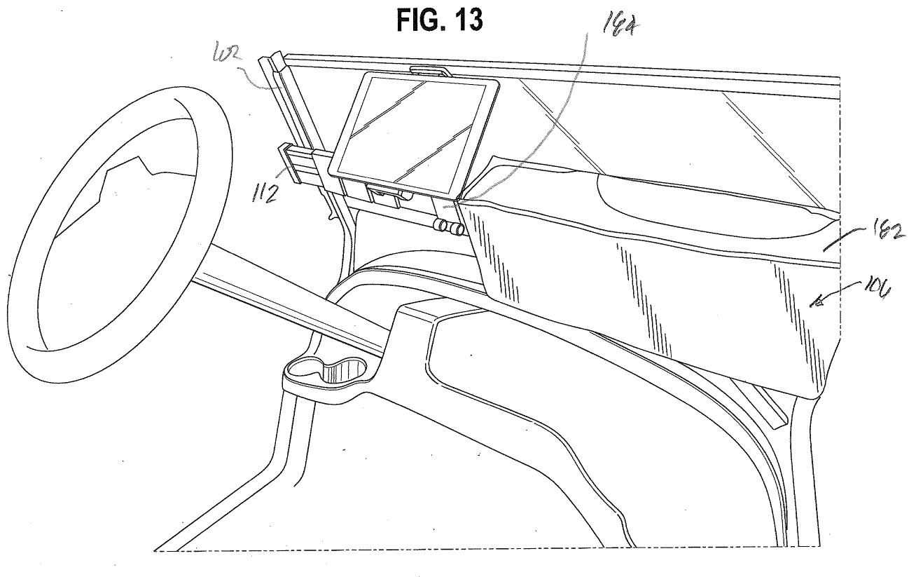

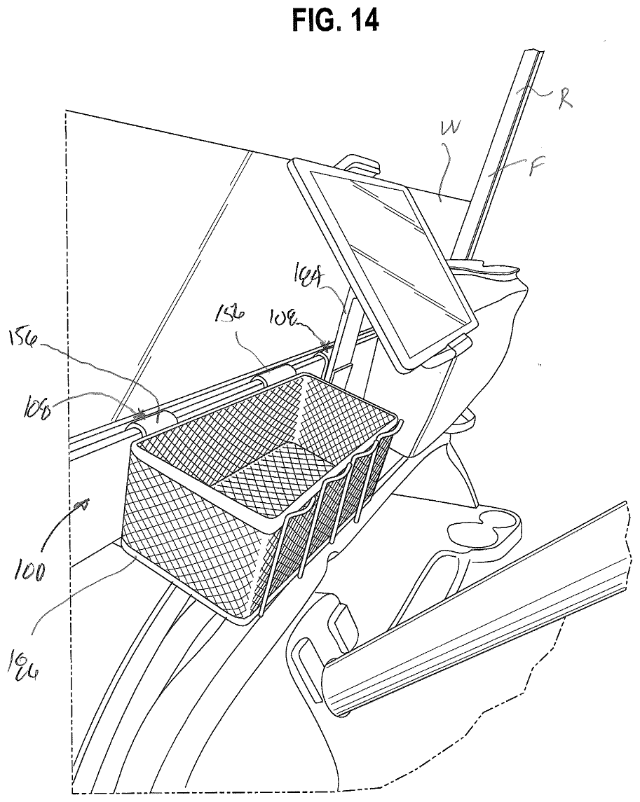

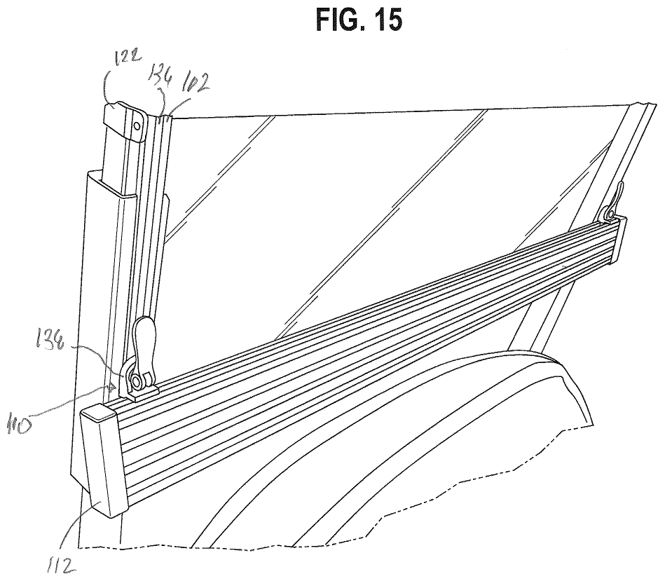

FIGS. 9 and 12 show the mounting bar 104; FIG. 12 shows the mounting bar 104 cross-section and FIGS. 13, 15 18, and 19 show the mounting bar with end caps 112 installed. In an embodiment, the mounting bar 104 has a cross-section that resembles a series of stacked Xs 114 with toes 116 at the ends of the Xs 114 and with the ends of the legs 118 of adjacent Xs 114 formed integral with one another. This configuration creates bounded slots 120 in the mounting bar 104 defined by the toes 116 of adjacent Xs 114. The bounded slots 120, as described below, provide for securing accessories 106 (such as storage members, for example, coolers, phone or table mounts and the like) to the mounting bar 104 via the fastening system 108. In embodiments, the mounting 104 bar is configured having the slots 120 in the top and bottom surfaces 121, 123 only. In such embodiments, the front face 125 of the mounting bar 104 is flat or flush.

In an embodiment, the mounting bar 104 is mounted to the side rails 102 which are mounted to the vehicle vertical rails R. The side rails 102 can be mounted to the vehicle vertical rails R in a wide variety of ways, for example, by fasteners such as screws or bolts, clamps 122 and the like (see, for example, FIG. 1). In embodiments, the side rails 102 are directly mounted to the vehicle vertical rails R. In other embodiments, the side rails 102 are mounted to the vehicle vertical rails R by clamps 122 or the like. The side rails 102 can include openings (not shown) to receive fasteners to secure the side rails directly to the vehicle vertical rails R.

The side rails 102 can also include openings (not shown) to secure the mounting bar 104 directly to the side rails 102. In embodiments, the mounting bar 104 is secured to the side rails 102 by fasteners such as screws or bolts.

In other embodiments, the mounting bar 104 is secured to the side rails 102 by angle brackets 124. As noted above, the vehicle vertical rails R may not be fully vertical, but may be at an angle, substantially vertical. For example, if the vehicle vertical rails R are uprights that support the windshield W, the windshield W may be set at an angle or raked (not unlike an automobile). In such arrangements it may be beneficial to be able to adjust the angle of the mounting 104 bar relative to the side rails 102 such that the front face 126 of the mounting bar 104 is vertical or near vertical.

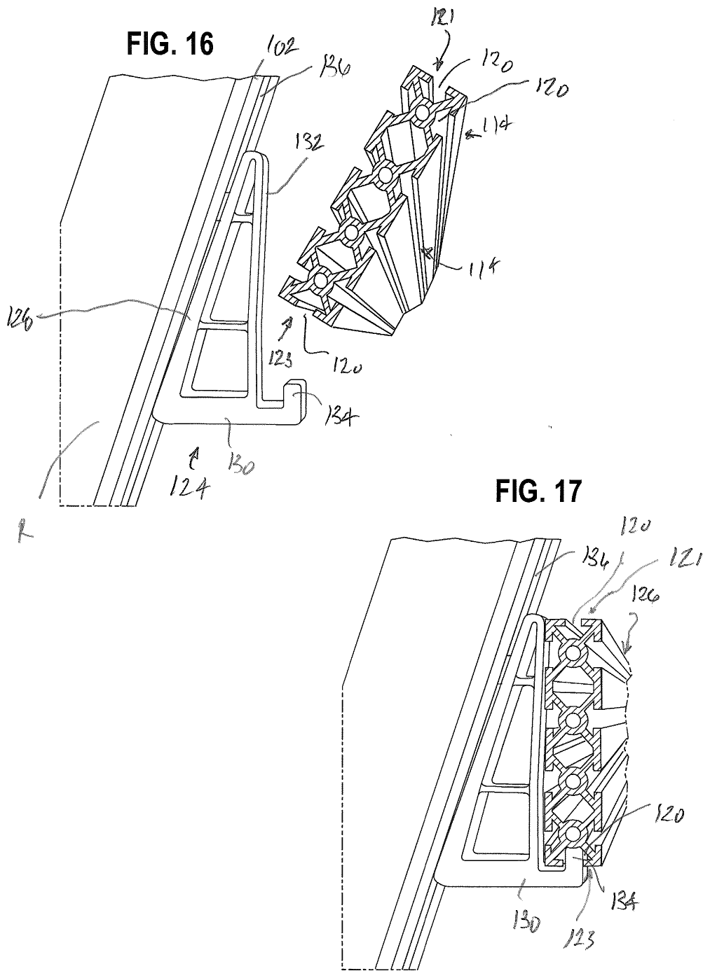

Referring to FIGS. 16-19 an angle bracket 124 is shown. The angle bracket 124 is configured to mount to the side rail 102 and provide a vertical surface against which the mounting bar 104 is secured to position the mounting bar 104 front face 126 in a vertical orientation. The angle bracket 124 includes a rail abutting leg 128, a bottom leg 130 and front leg 132. The angle bracket 124 is secured to the side rail 102 by one or more fastener, such as a bolt or screw at the rail abutting leg 128. In a present embodiment the angle bracket is secured to the side rails 102 by set screws (not shown) set into the bracket 124 and tightened onto the side rails 102. The bottom leg 130 has an upturned finger 134 that is received in a bounded slot 120 in the mounting bar 104. When using the angle bracket 124, the rails 102 can be formed having a C-shape with a bounded channel 136 as seen in FIGS. 15 and 18-19.

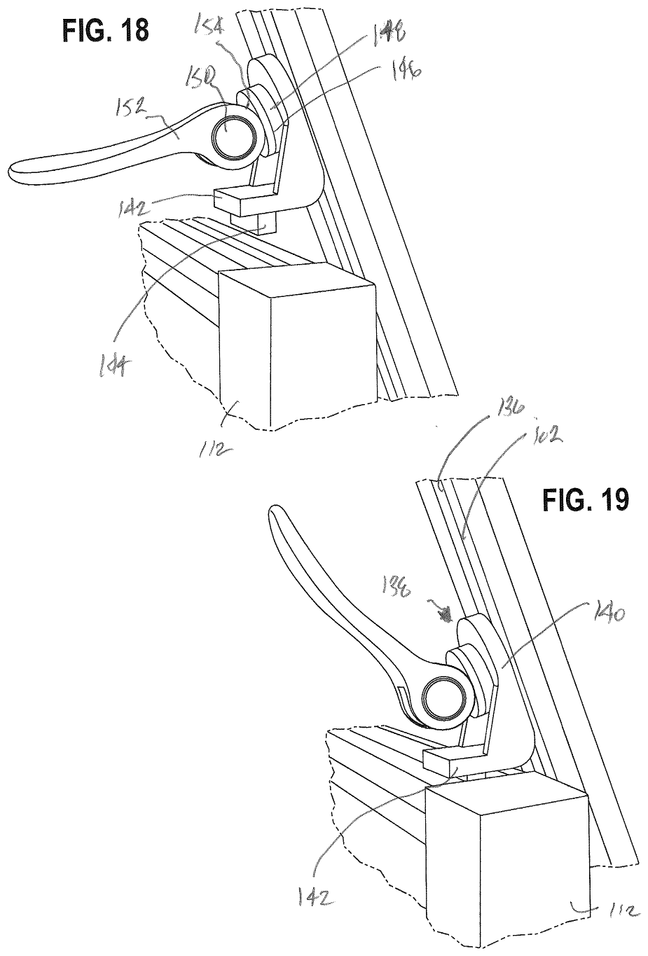

To secure the mounting bar 104 to the side rail 102, in an embodiment, a sliding clamp 138 is positioned in the channel 136 in the side rail 102. As seen in FIGS. 18 and 19, the sliding clamp 138 includes a base portion 140 that slides along an outer surface of the side rail 102, a horizontal leg 142 extending from the base portion 140, and a finger 144 extending transverse to the horizontal leg 142.

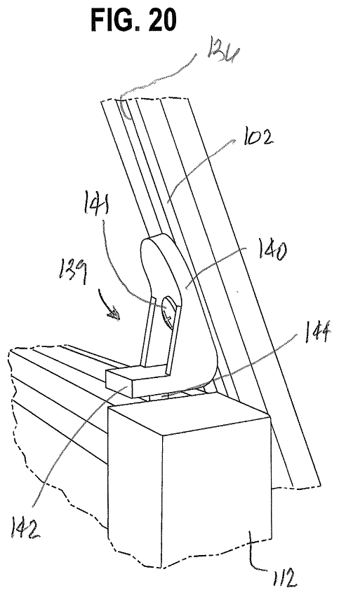

A cammed lock 146 is positioned on the base portion 140. The cammed lock 146 includes an inner member (not shown) that is positioned in the side rail channel 136 and a connecting pin 148 that extends from the inner member to a transverse pivot pin 150. A lever or handle 152 is pivotally mounted to the pivot pin 150. The handle 152 includes a cam surface 154 that, when rotated urges the inner member against an inner surface of the side rail channel 136. An alternate embodiment of the clamp 139 is illustrated in FIG. 20. In this embodiment, a base portion 140, horizontal leg 142 and a finger 144 are similar to that of the clamp 138 of FIGS. 18 and 19, but the cammed lock is replaced with a fastener such as a set screw 141 to secure the clamp 139 in place in the mounting bar 104 and fastened to the side rails 102.

In this arrangement, the mounting bar 104 is positioned on the angle bracket 124 with the angle bracket finger 134 positioned in a bounded slot 120 at the bottom of the mounting bar 104. The sliding clamp 138 is moved into position at the top of the mounting bar 104 with the sliding clamp finger 144 positioned in a bounded slot 120 in the top of the mounting bar 104 for locking in place. The lever 152 is pivoted such that the cam surface 154 rotates and urges the inner member against an inner surface of the side rail channel 136. This locks the clamp 138 in place to secure the mounting bar 104 to the side rails 102 with the front face 126 in a vertical or substantially vertical position.

It will be appreciated that in any of the foregoing embodiments, the height of the mounting bar 104 relative to or along the vehicle vertical rails R can be adjusted higher or lower by positioning the mount bar 104 or the angle brackets 124 at a higher or lower location along the side rails 102.

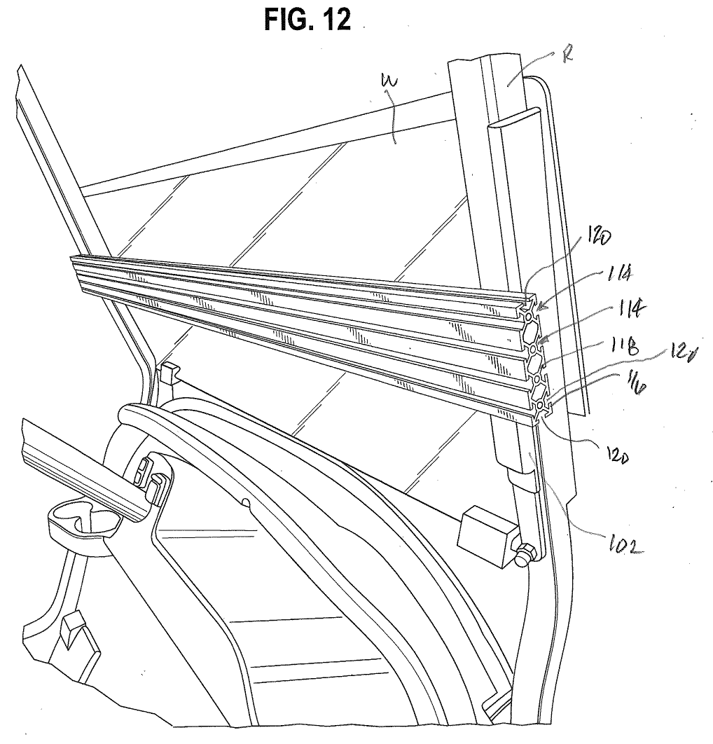

To mount or attach any of the accessories 106 (such as storage members, baskets, mounts etc.), clips 156 such as those shown in FIGS. 10 and 11 are mounted to or formed integral with the accessory 106. The clip 156 illustrated in FIG. 10 includes a rear wall 158 and upper and lower forwardly extending legs 160, 162. The upper leg 160 includes a forwardly extending hook 164, the end 166 of which turns downward. The lower leg 162 includes a forwardly extending foot 168 with an upwardly extending toe 170 at or near an end of the foot 168.

The clip 156 engages with the mounting bar 104 by insertion of the upper leg hook 164 into an upper bounded slot 120 in the mounting bar 104 and urging the lower leg 162 toward the mounting bar 104 such that the lower foot 168 engages a lower surface of the mounting bar 104 and the toe 170 engages a bounded slot 120 in the lower surface of the mounting bar 104 to secure the clip 156 to the bar 104.

The clip 156 illustrated in FIG. 11 has a similar shape and function to illustrated in FIG. 10. The clip 156 has a rear wall 172 and upper and lower forwardly extending legs 174, 176. The upper leg 174 extends forwardly and upwardly, and has a downwardly extending toe 178 at its end. The lower leg 176 extends forwardly and downwardly and has a bent toe 180 at about its end. Like the clip of FIG. 10, the upper leg toe 178 inserts in to an upper bounded slot 120 in the mounting bar 104 and the lower leg 176 is urged toward the mounting bar 104 such that the lower leg 176 engages a lower surface of the mounting bar 104 and the toe 180 engages a bounded slot 120 in the bottom surface of the mounting bar 104 to secure the clip 156 to the bar 104.

The clips 156 can be formed from a material having elastic deformation, such that when the lower leg 162, 176 is urged toward and onto the mounting bar 104 and flexes to engage the lower leg 162, 176 with the lower surface of the mounting bar 104, the clip 156 returns to its original shape to secure the clip 156 on the mounting bar 104. To facilitate securing the clips 156 to the mounting bar 104, to, for example prevent the clips and accessories 106 from “rattling” the clamps 156 can include a pad 157, such as a rubber pad, on an inner surface 159 of the clip 156 to ensure a tight fit to the mounting bar 104.

As noted above, the clip 156 can be mounted or affixed to an accessory. For example, the clip 156 can be mounted to the rear wall of a cooler 182 or mounted to a phone or tablet mount 184. In another example, the clip 156 can be formed integral with the mount 184 or formed integral with a basket 186 or like accessory for holding, for example, pens, score cards and the like.

It will be appreciated that although the vehicle accessory carrier system 10, 100 is described in connection with golf carts, the system 10, 100 can be used with other vehicles that include uprights or vertical posts, such as all-terrain vehicles (ATVs) and the like, and that all such uses of the system 10, 100 are within the scope and spirit of the present disclosure.

The words “a” or “an” are to be taken to include both the singular and the plural. Conversely, any reference to plural items shall, where appropriate, include the singular. The words “first,” “second,” “third,” and the like may be used in the present disclosure to describe various information, such information should not be limited to these words. These words are only used to distinguish one category of information from another. The directional words “top,” “bottom,” up,” “down,” front,” “back,” and the like are used for purposes of illustration and as such, are not limiting. Depending on the context, the word “if” as used herein may be interpreted as “when” or “upon” or “in response to determining.”

From the foregoing it will be observed that numerous modifications and variations can be effectuated without departing from the true spirit and scope of the novel concepts of the present disclosure. It is to be understood that no limitation with respect to the specific embodiments illustrated is intended or should be inferred. The disclosure is intended to cover by the appended claims all such modifications as fall within the scope of the claims.

1. A vehicle accessory carrier system for mounting to opposing upright members of the vehicle, the system comprising:
a mounting bar extending between and operably connected to the opposing upright members, the mounting bar having upper and lower surfaces, the upper and lower surfaces having slots therein;
one or more accessory carriers removably mounted to the mounting bar; and
a mounting system for removably mounting one of the one or more accessory carriers to the mounting bar, the mounting system including one or more clips, each of the one or more clips having a rear wall, an upper forwardly extending leg and a lower forwardly extending leg, the upper forwardly extending leg including a forwardly extending hook, an end of the hook turning downward, the lower forwardly extending leg including a forwardly extending foot having a securing member at or near an end of the lower leg foot,
wherein the clip upper forwardly extending leg hook inserts into the mounting bar upper surface slot and the clip lower forwardly extending leg secures onto the mounting bar at about the lower surface to secure the one of the one or more accessory carriers onto the mounting bar.

2. The system of claim 1, wherein the clip lower forwardly extending leg includes a securing member.

3. The system of claim 2, wherein the securing member is an upwardly extending toe at or near an end of the foot.

4. The system of claim 3, wherein the upwardly extending toe inserts into the mounting bar lower surface slot.

5. The system of claim 1, wherein the clip is formed from an elastically deformable material.

6. The system of claim 5, wherein the elastically deformable material is a polymeric material.

7. The system of claim 2, wherein the securing member is a lower leg bent toe at about the end of the lower leg foot, and wherein the bent toe engages the mounting bar lower surface slot to secure the one of the one or more accessory carriers onto the mounting bar.

8. The system of claim 7, wherein the clip is formed from an elastically deformable material.

9. The system of claim 8, wherein the elastically deformable material is a polymeric material.

10. The system of claim 1, wherein the clip is formed integral with the one of the one or more accessory carriers.

11. The system of claim 1, wherein the clip is mounted to the one of the one or more accessory carriers.

12. The system of claim 1 further including mounting rails, wherein the mounting bar is mounted to the mounting rails, and wherein the mounting rails are adapted to mount to the opposing upright members of the vehicle.

13. The system of claim 1 further including mounting rails and angled mounting brackets, wherein the angled mounting brackets are mounted to the mounting rails, and the mounting bar is mounted to the angled mounting brackets, and wherein the mounting rails are adapted to mount to the opposing upright members of the vehicle.

14. The system of claim 13, wherein the angled mounting brackets have a rail abutting leg, a bottom leg and upturned front lip at an end of the bottom leg, and wherein the mounting bar is positioned on the angled bracket with the upturned front lip inserted into the lower surface slot.

15. The system of claim 13, wherein the rails have a bounded C-shaped cross-section.

16. The system of claim 15 further including a sliding lock, the sliding lock configured for sliding along the rail, the sliding cam lock having finger extending therefrom for engagement with the mounting bar lower surface slot.

17. The system of claim 16, wherein the sliding lock includes a handle, and wherein the handle has a cam surface to engage a lock.

18. The system of claim 1, wherein the one or more accessory carriers is one or more of a cooler, a basket, a phone or tablet holder, and a cup holder.

19. A vehicle accessory carrier system for mounting to opposing upright members of the vehicle, the system comprising:
a pair of side rails, the side rails adapted to mount to the opposing upright members of the vehicle;
a mounting bar extending between and operably connected to the side rails, the mounting bar having upper and lower surfaces;
one or more accessory carriers removably mounted to the mounting bar; and
a mounting system for removably mounting one of the one or more accessory carriers to the mounting bar, the mounting system including one or more clips, each of the one or more clips having a rear wall, an upper forwardly extending leg and a lower forwardly extending leg,
wherein the clip upper forwardly extending leg engages the mounting bar at about the upper surface and the clip lower forwardly extending leg engages the mounting bar at about the lower surface to secure the one of the one or more accessory carriers onto the mounting bar.

20. The system of claim 19, wherein the side rails have a bounded C-shaped cross-section.

21. The system of claim 19, wherein the mounting bar upper surface has a longitudinally extending slot therein, and wherein the mounting bar lower surface has a longitudinally extending slot therein.

22. The system of claim 21 wherein the mounting system further includes angled mounting brackets mounted to the mounting rails,
wherein the mounting system further includes a lock configured for securing to the side rail, and
wherein the mounting bar is secured in place on and between angled mounting bracket and the lock.

23. The system of claim 22, wherein the lock is a sliding cam lock configured for sliding along the rail, and wherein the mounting bar is secured in place on and between angled mounting bracket and the sliding cam lock.

24. The system of claim 21, wherein the clip upper forwardly extending leg includes a forwardly extending hook, an end of the hook turning downward, and wherein the lower forwardly extending leg includes a forwardly extending foot having a securing member at or near an end of the lower leg foot, and wherein the clip upper forwardly extending leg hook inserts into the mounting bar upper surface slot and the clip lower forwardly extending leg securing member secures onto the mounting bar at about the lower surface slot to secure the one of the one or more accessory carriers onto the mounting bar.
